(19) United States
(12) Patent Application Publication
(10) Pub. No.: US 2008/0011907 A1
(43) Pub. Date: Jan. 17, 2008

(54) Intravenous line organizer

(76) Inventor: Paul M. Jacobsma, Sioux City, IA (US)

Correspondence Address: Paul E Schaafsma, Novuslp, LLC, Suite 221, 521 West Superior Street, Chicago, IL, 60610-3135, US

(21) Appl. No.: 11/485,900

(22) Filed: Jul. 13, 2006

(51) Int. Cl. E21F 17/02; F16L 3/00

(52) U.S. Cl. 248/62

(57) ABSTRACT

In accordance with the principles of the present invention, an intravenous line organizer is provided. The intravenous line organizer comprises a clamp provided to encircle and connects the intravenous line organizer to an IV pole at a desired height on the IV pole. In one embodiment, the clamp is an adjustable clamp so that it can accommodate different IV poles that might have different widths. A plurality of hooks are connected to the clamp. IV tubing can be thread onto the hooks to suspend the IV lines off the floor.

### FIELD OF THE INVENTION

The present invention relates to intravenous line organization.

### BACKGROUND OF THE INVENTION

It is routine medical practice in most health care facilitates to treat and medicate a patient by introducing therapeutic agents, drugs, medicines, nutrients, and various other liquids directly into the blood stream through systems commonly known as intravenous (IV) administration systems. A typical, commonly utilized IV administration system consists of a length of transparent IV tubing having a hollow needle coupled to each end. The needle on one end of the tubing is adapted to be inserted, through a sealing member, into a supply reservoir containing a prescribed medication or other prescribed liquid. The reservoir may be in the form of a bag or a bottle, and is generally suspended, with the coupling to the tubing at a lowest elevation, from a pole so as to be above the level of the patient, thus enabling gravity flow of the liquid into the tubing. The needle on the other end of the IV tubing is adapted to be insertable into a venous blood vessel of the patient, or into a device known as an infusion port coupled to a needle inserted appropriately into the patient.

To allow for slack, to accommodate remote placement of the supply reservoir relative to the patient, and to accommodate patient movement and access to the patient by health care professionals, the length of the IV tubing associated with the IV administration system is typically significantly longer than that necessary to reach from the supply reservoir to the patient. In addition, during the course of medical procedures, a human patient is often infused simultaneously with a plurality of different medications and fluids. Indeed, it is not uncommon for a critically ill patient to have ten to fifteen, or even more, different IV administration systems simultaneously connected to the patient. Many of these IV administration systems are placed on the patient even prior to transportation of the patient from a surgery area to a convalescing area.

The entanglement of numerous IV administration systems is common in the hospital room while the patient is recovering from a surgical operation. This entanglement can be by the patient moving around in either a conscious or unconscious state. This problem is aggravated by the tendency of each of the IV tubes to coil (back to their packaged configuration) and consequently tangle with other IV tubes. This action can cause the catheter to be pulled from its site of origin.

Another problem which may commonly occur is the problem of excess IV tubing. Health and safety guidelines for most hospitals currently prohibit intravenous IV tubes from touching the floor. The need to avoid touching the floor is designed to lessen the danger of touch contamination. Despite these guidelines, this problem is continually happening because due to the length of the IV tube the tubing often lies on the floor of the hospital or healthcare setting. Having the IV tubing lying on the floor puts the patient at risk because the accidental dislodgement often times occurs as the lengthy IV tubing gets caught on an object the bed, the IV pole, the wheels of the IV pole, etc and the line gets taught as the patient moves in the opposing direction. Furthermore, the patient is at risk because the healthcare personal or the patient can step or possibly trip and pull the IV tubing and catheter as they are moving around the hospital or healthcare environment.

When dislodgement occurs the patient is at risk because the medications, chemotherapy or hydration that is being delivered through the tubing and into the catheter is not being delivered to the intended location. As a result, the IV fluid or medication is being delivered outside of the patient's vein and this can cause minor or extensive trauma to the patient's organs and surrounding tissues

Furthermore, the lengthy IV tubing hinders the patient's freedom of movement. When a patient is transported or walks through more narrow hospital corridors or past other patients having similar connections, particularly when turning corners, there is a risk that lines will be disturbed or even disconnected if caught on a projection. Each time the patient wants to move around the healthcare setting they have to closely monitor and maneuver so that their tubing does not get caught on a surrounding object or stepped on. In addition, the patient needs to hold the lines of tubing off the ground in one hand while they may have to push the IV pole with the other. A mass of entangled lines and IV tubes also gives family members and loved ones anxious feelings when seeing a patient treated in this manner.

There is a need within the hospital room for a device to which the different lines that are connected to the patient can be separate and untangled. One attempt to clear away the confusion involves wrapping the IV tube around the bag to take up the slack. Unfortunately, this arrangement can injure the patient when the patient rolls or moves; the IV tube cannot “give” or expand so the needle is pulled out of the patient. Other approaches have attempted to secure the IV tube through the use a clamp or support type of mechanism. In these approaches, the IV tube is secured but the flexibility permitting the patient to roll or move is not present.

There have been several proposals to arrange intravenous lines that have been intended to label rather than protect the various/signal carrying conduits. Although mechanisms of this kind help with labeling and identifying various lines, they do nothing to protect these IV tubes and wires lengthwise from becoming overly entangled and caught up on projections or other articles during transport. The need therefore remains for a simple but effective means to both organize and protect intravenous lines and IV tubes to ensure a tidy yet functional arrangement.

To allow the patient to move, a variety of techniques have secured the IV tube to the patient through the use of a bracelet approach. Although those devices do prevent the hollow IV needle from being pulled from the patient, in use, as the patient rolls, the pull on the tubing causes the IV container and support bracket to be pulled over. This is an even more dangerous situation than if the needle had been pulled out.

To address this issue, a variety of devices have been designed to more securely affix the IV bag. The basic structure of these patents result in the IV tubing being even less flexible since the tubing is more securely fastened to the IV bag and support. This only restricts the patient's movement more.

None of such individually improvised measures has achieved a level of acceptance that would indicate development of a standard procedure or approach that could be adopted for use by all health care professionals and institutions. The device should also be easily transportable with the IV reservoirs as the patient moves from location to location. In short, none of the prior art, either alone or in combination, provides an intravenous IV tube holder for use in a trauma unit which can alternatively allow for the retention of multiple intravenous IV tubes and to organize and maintain the plurality of the IV lines. The need than still remains to develop an affordable yet simple device that permits movement of the patient without the threat of injury and also allows for easy organization of single or multiple IV tubes simultaneously

### SUMMARY OF THE INVENTION

An intravenous line organizer in accordance with the principles of the present invention provides an intravenous IV tube holder for use in a trauma unit which can alternatively allow for the retention of multiple intravenous IV tubes and to organize and maintain the plurality of the IV lines. An intravenous line organizer in accordance with the principles of the present invention is easily transportable with the IV reservoirs as the patient moves from location to location. An intravenous line organizer in accordance with the principles of the present invention is an affordable yet simple device that permits movement of the patient without the threat of injury and also allows for easy organization of single or multiple IV tubes simultaneously.

In accordance with the principles of the present invention, an intravenous line organizer is provided. The intravenous line organizer comprises a clamp provided to encircle and connects the intravenous line organizer to an IV pole at a desired height on the IV pole. In one embodiment, the clamp is an adjustable clamp so that it can accommodate different IV poles that might have different widths. A plurality of hooks are connected to the clamp. IV tubing can be thread onto the hooks to suspend the IV lines off the floor.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 a perspective view of an intravenous line organizer in accordance with the principles of the present invention on an intravenous administration device.

FIG. 2 is a detailed perspective view of the intravenous line organizer of FIG. 1 on an intravenous administration device.

FIG. 3 is a detailed perspective view of the intravenous line organizer of FIG. 1.

FIG. 4 is a top view of the intravenous line organizer of FIG. 1 in the open position.

FIG. 5 is a top view of the intravenous line organizer of FIG. 1 in the closed position.

FIG. 6 is an elevated side view of the intravenous line organizer of FIG. 1.

FIG. 7 is an exploded perspective view of another embodiment of an intravenous line organizer in accordance with the principles of the present invention.

FIG. 8 is a detailed perspective view of the intravenous line organizer of FIG. 7.

FIG. 9 is a top view of the intravenous line organizer of FIG. 7.

FIG. 10 is a side view of the intravenous line organizer of FIG. 7.

FIG. 11 is a perspective view of another embodiment of an intravenous line organizer in accordance with the principles of the present invention.

FIG. 12 is a top view of the intravenous line organizer of FIG. 11.

FIG. 13 is a side view of the intravenous line organizer of FIG. 11.

### DETAILED DESCRIPTION OF THE INVENTION

In accordance with the principles of the present invention, a clamp is provided that encircles and connects to an IV pole. The clamp can preferably be an adjustable securement member so that it can be adjusted to the desired height on the IV pole. Also, an adjustable clamp can accommodate different IV poles that might have different widths.

In accordance with the principles of the present invention, the clamp is provided with hooks connected to it. The hooks will keep the IV lines suspended off the floor. The patient or the nurse can thread the IV tubing onto the hooks and the lines will now be suspended off the floor. This allows the patient to transfer around the facility without having to hold onto the lines and the lines will not become entangled with the IV pole that will be transferring with the patient. Additionally, the lines will be off the ground and will not be stepped on by the patient or other healthcare employees and the lines will have a smaller chance of becoming entangled with surrounding objects.

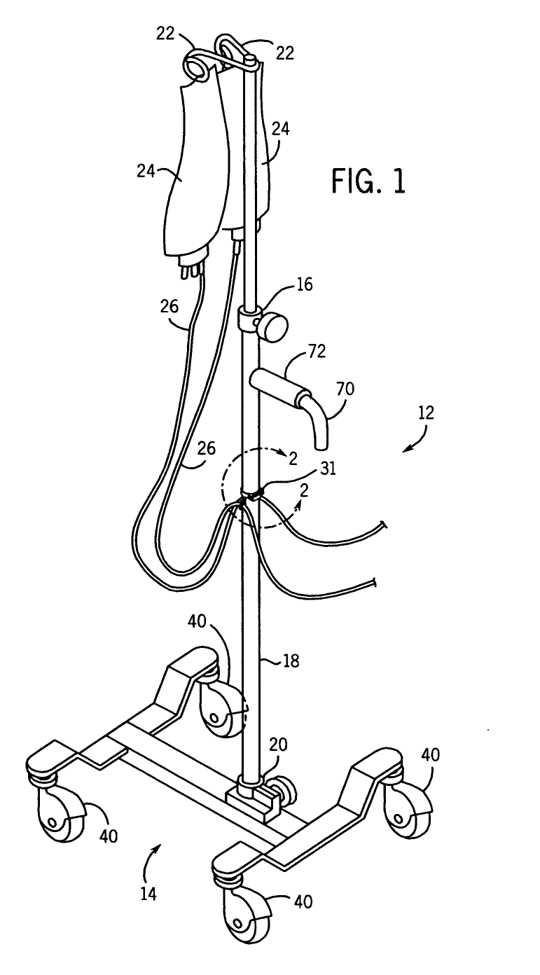

Referring to FIGS. 1-6, an intravenous line organizer in accordance with the principles of the present invention is seen. As previously discussed, the intravenous line organizer in accordance with the principles of the present invention is designed to be secured to an intravenous administration device 12. FIG. 1 shows a perspective view of an intravenous line organizer in accordance with the principles of the present invention on an intravenous administration device 12. An intravenous administration pole 12 can has a base 14, an upwardly extending, and a telescopically extending pole 18 secured to the base by a clamp 20. An adjustment knob 16 can be provided to enable telescopically extending pole 18 to be adjusted. A plurality of wheels 40 can be provided on the base 14 to effectuate mobility of the intravenous administration device 12. A handle 70 having a grip enhancing material such as a rubber sleeve 72 is secured to the telescopically extending pole 18. At least one arm 22 is provided to hold a parenteral administration container 24. The parenteral administration container 24 can have at least one the IV line 26 spiked into an access port to gain access to the parenteral fluid contained within the parenteral administration container 24.

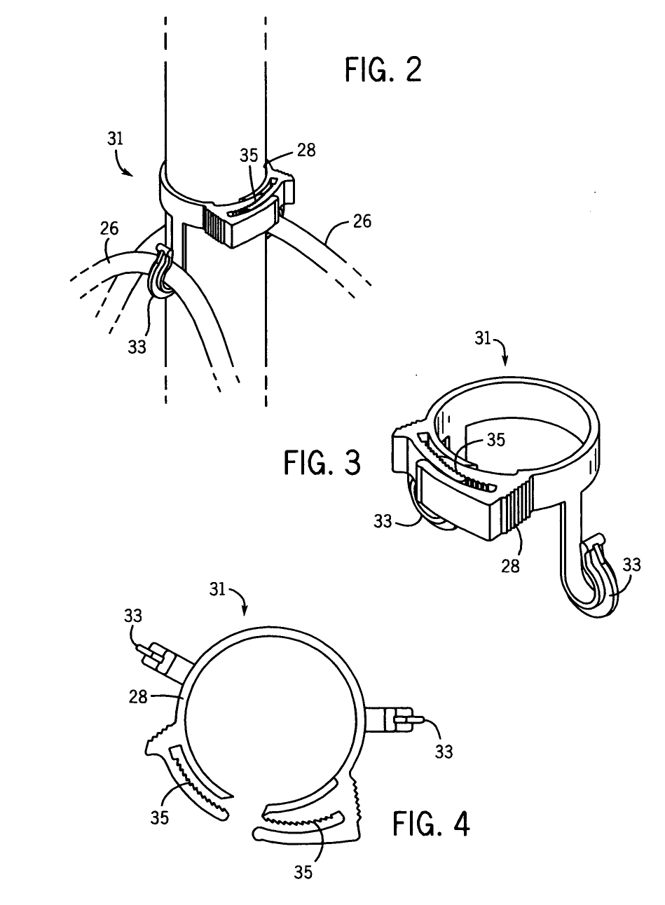

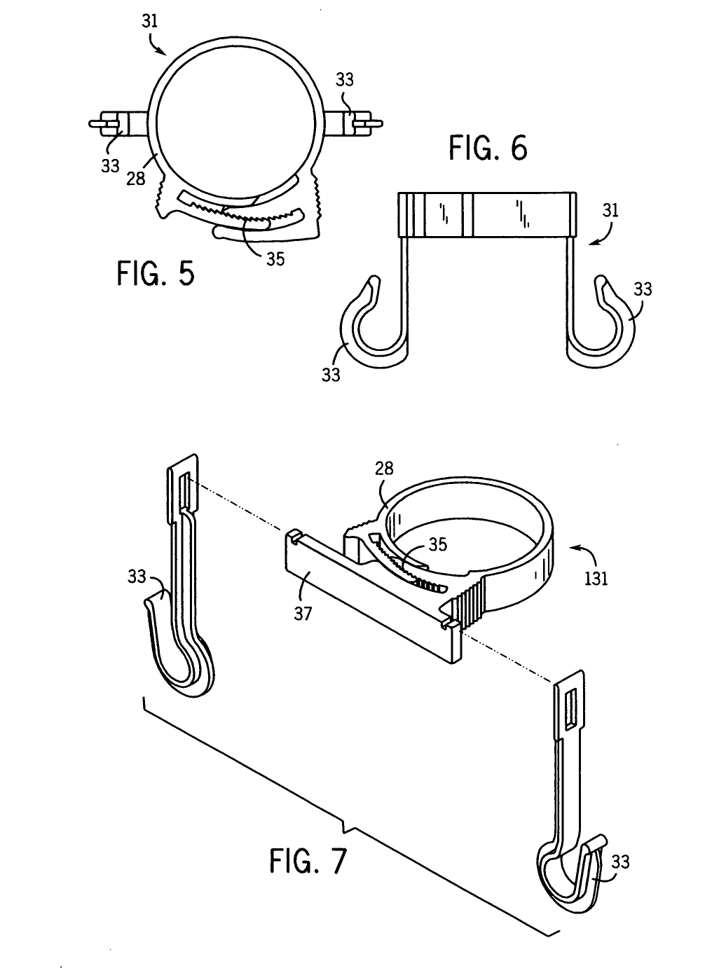

Referring now to FIGS. 2-6, detailed views of the intravenous line organizer of FIG. 1 on an intravenous administration device are seen. The intravenous line organizer 31 is designed to be secured on the intravenous administration device in general, and in a preferred embodiment on the pole 18 by an adjustable securement member 28. The adjustable securement member 28 can include a pair of cooperating teeth 35 as best seen in FIGS. 4 and 5, where FIG. 4 is a top view of the intravenous line organizer of FIG. 1 in the open position while FIG. 5 is a top view of the intravenous line organizer of FIG. 1 in the closed position.

The intravenous line organizer includes at least one hook 33; while in the embodiment described herein two hooks 33 are depicted any number of a plurality of hooks is within the scope of the invention. The hooks 33 are designed to receive and removably secure an IV line 26, as best seen in FIG. 2.

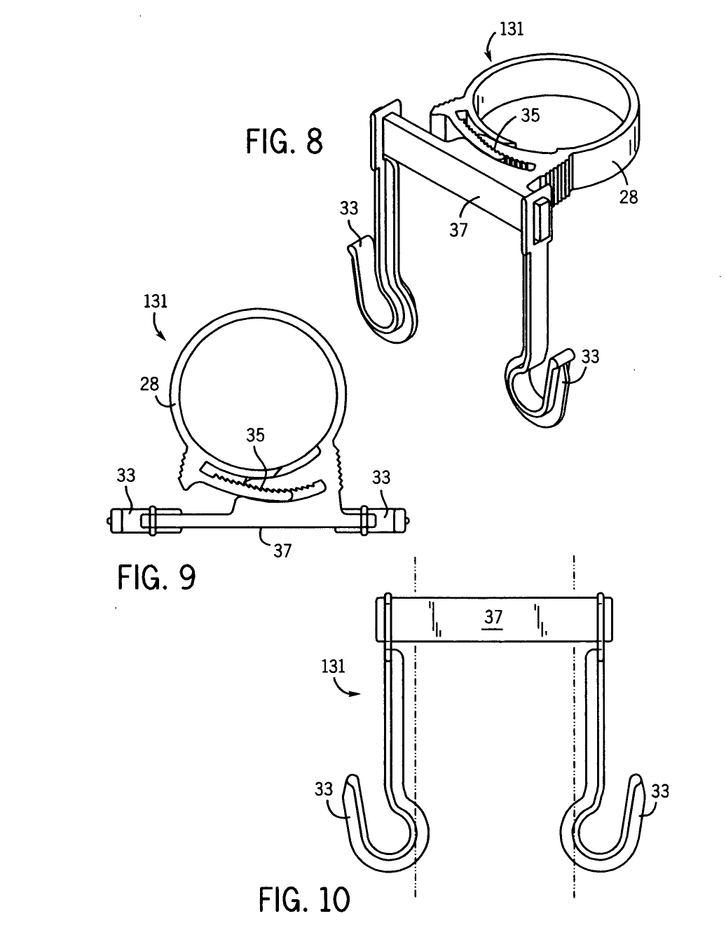

Referring now to FIGS. 7-10, another embodiment of an intravenous line organizer 131 in accordance with the principles of the present invention is seen. In this embodiment, a horizontally extending member 37 is provided on which the hooks 33 are provided. In one embodiment, the hooks 33 can be removably secured to the horizontally extending member 37, as seen in the exploded perspective view of FIG. 7; while in the embodiment described herein the hooks 33 are depicted as removable, non-removably secured hooks are also within the scope of the invention.

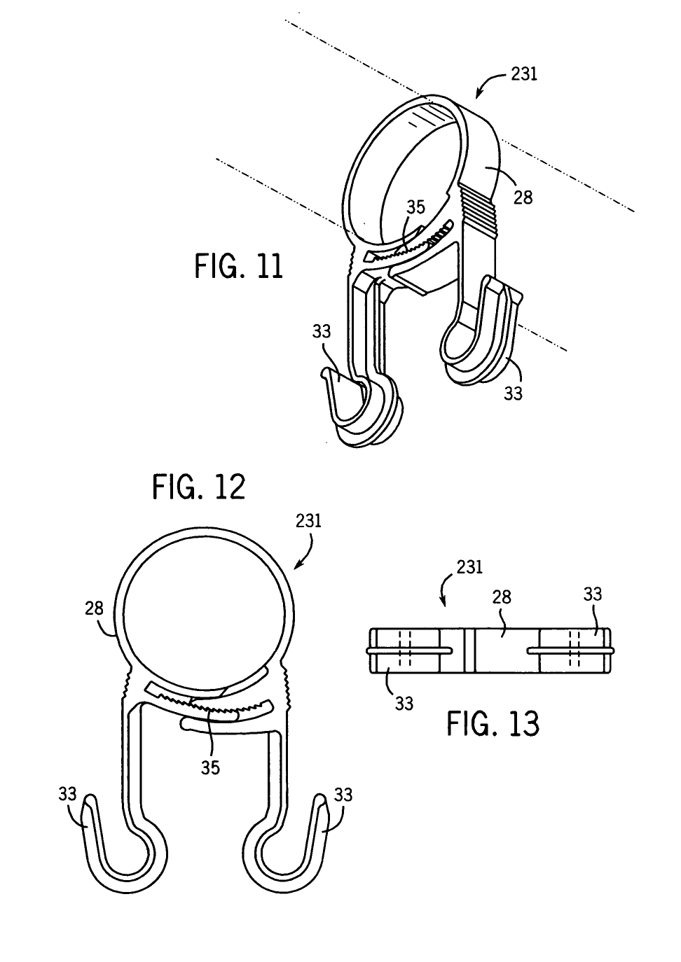

Some embodiments of intravenous administration devices include a horizontally extending pole. Referring now to FIGS. 11-13, a perspective view of another embodiment of an intravenous line organizer 231 in accordance with the principles of the present invention is seen. In this embodiment, the hooks 33 are provided extending in the same plane as the plane of the adjustable securement member 28; thus, when attached to a horizontally extending pole, the hooks extend downwardly.

Thus, an intravenous line organizer in accordance with the principles of the present invention will lower the incidence of having central and peripheral lines pulled out of patient's veins. An intravenous line organizer in accordance with the principles of the present invention will benefit the patient by saving them money and it will add to their safety. An intravenous line organizer in accordance with the principles of the present invention could also save the hospital money because the hospital would not have to use as many supplies to keep the IV tubes safe and in place. Finally, an intravenous line organizer in accordance with the principles of the present invention will allow the patient to ambulate more safely and with less difficulty and it will help reduce workplace clutter because the tubing lines are not lying on the hospital floor.

While the invention has been described with specific embodiments, other alternatives, modifications and variations will be apparent to those skilled in the art. Accordingly, it will be intended to include all such alternatives, modifications and variations set forth within the spirit and scope of the appended claims.

What is claimed is:

1. An intravenous line organizer comprising:
a securement member provided to encircle and connect to an IV pole at a desired height on the IV pole;
a plurality hooks connected to the securement member;
such that the IV tubing can be thread onto the hooks to suspend the IV lines off the floor.

2. The intravenous line organizer of claim 1 further wherein the securement member is an adjustable securement member so that it can accommodate different IV poles that might have different widths.

3. The intravenous line organizer of claim 1 further wherein the adjustable securement member comprises a pair of cooperating teeth.

4. The intravenous line organizer of claim 1 further comprising a horizontally extending member on which the hooks are provided.

5. The intravenous line organizer of claim 1 further wherein the hooks are removably secured.

6. The intravenous line organizer of claim 1 further wherein the hooks are provided extending in the same plane as the plane of the adjustable securement member.
